(19) United States
(12) Patent Application Publication
(10) Pub. No.: US 2005/0203978 A1
(43) Pub. Date: Sep. 15, 2005

(54) Analysis apparatus arranged to analyse data and detect change and related methods

(76) Inventor: Maurice Haman Abraham, Reading (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/894,805

(22) Filed: Jul. 20, 2004

(30) Foreign Application Priority Data
Jul. 24, 2003 (GB) 0317304.4

(51) Int. Cl. G06F 7/00

(52) U.S. Cl. 708/200

(57) ABSTRACT

A method of analysing data comprising collecting at least one new data sample and using the new data sample and an existing ongoing weighted average based upon at least one earlier data sample to calculate new ongoing weighted average such that a respective weight applied to the at least one earlier data sample used to calculate the existing ongoing weighted average is diminished without needing the value of the at least one earlier data sample to calculate the new ongoing weighted average. A ongoing weighted standard deviation may be used. The method may be used to determine whether a new data sample differs by more than an acceptable amount from earlier data samples.

### TECHNICAL FIELD OF THE INVENTION

This invention relates to an analysis apparatus arranged to analyse data and detect change and related methods. Such systems may include file transfers, sales, weather recording, etc.

### BACKGROUND OF THE INVENTION

An apparatus which detects significant changes in a system has many uses. There follow a few examples that give an indication of the great variety of applications for such apparatus.

Consider first a measure of pressure in a gas conduit. A sudden increase above a certain threshold may indicate a blockage, a sudden decrease may indicate a leak. Therefore, the detection in the change of pressure within the conduit may provide a technical advantage in the detection of problems therein.

Alternatively, consider the sales trends of a product. A sudden rise in demand may indicate that the manufacture of the product should be stepped up or that more deliveries should be made. A sudden dip may indicate that production should be scaled back or that the ordering system has failed. Therefore, the detection of the change in sales of a product may provide useful feedback that can improve the efficiency of a company.

In another example, consider a file transfer system on a computer. It is often desirable to know the time to completion of a file transfer and the rate at which the transfer occurs may depend on network usage or other variable parameters. A change in transfer rate may indicate that the time to completion should be altered and as such may provide for more accurate scheduling of tasks and the like.

In the past, such apparatus has often comprised detection means arranged to collect data. The collected data is then compared to ‘normal’ data, i.e., that which might be normally be expected, and it is decided whether the collected data is anomalous. The expected data often comprises historical data and may be a historical mean—this assumes that the past behaviour of a system is likely to be a good indication of how the system behaves in the future. This may be the arithmetic mean found by summing the value of the data points and dividing by the number of data points taken, as represented by the equation:

$$μ = \frac{{\sum }_{i = 1}^{n} {x}_{i}}{n}$$

Where μ is the arithmetic mean, n is the number of data points taken and xᵢ is the ith data point where i goes from 1 to n.

Further, in order to decide if a data point is anomalous, the statistical measure of standard deviation is often used. FIG. 1 shows how standard deviation gives a measure of the spread of data—depending on the system, an alert may be appropriate when the data falls outside of two standard deviations of the arithmetic mean, or perhaps within three standard deviations, or some other number. Standard deviation is calculated using the equation:

$$σ = \sqrt{\frac{{\sum }_{i = 1}^{n} ( {x}_{i}^{2} - {μ}^{2} )}{n}} or σ = \sqrt{\frac{{\sum }_{i = 1}^{n} {( {x}_{i} - μ )}^{2}}{n}}$$

where σ is the standard deviation.

An historical average may be calculated from all the data points gathered before, i.e. it uses historical data. However, using historical data in this way has its drawbacks in many practical systems as outlined below.

In many systems, it is preferable to weight data according to its importance. For example, it may be that data gathered recently is more important, i.e. more of a guide for future performance, than that gathered some time previously-consider any system with a trend such as selling price or with seasonal variations such as sales figures. Therefore, the amount of weight given to a particular data point may vary over time.

The mean can be calculated if the full set of data points is stored. However, this data set can grow to be large (consider sales figures stretching back years, for example) and requires this data to be maintained indefinitely. With each new data point gathered, this weighted average will have to be recalculated using the full set of data points as the weight associated with each data point changes with each further data point collected. Further, the standard deviation would also have to be recalculated. Storing large data sets and recalculating the weighted average and standard deviation every time a new data point is taken requires storage space (which may be memory on a computer system) and computational time.

### SUMMARY OF THE INVENTION

According to a first aspect of the invention there is provided an analysis apparatus arranged to analyse data and detect change within the data; the apparatus comprising an input means allowing at least one data sample to be input to the analysis apparatus, processing means arranged to receive the data sample from the input means and perform processing thereon, and memory arranged to allow the processing means to store data therein and retrieve data therefrom, on receipt of a data sample the processing means arranged to access an existing ongoing weighted average based upon at least one earlier data sample held in the memory and calculate a new ongoing weighted average using the received data sample and the existing ongoing weighted average wherein the new ongoing weighted average is calculated such that the weight applied to the or each earlier data sample is diminished without needing the value of the or each earlier data sa mp le calculate the new ongoing weighted average.

Such an apparatus is convenient because it reduces the amount of memory that is required by the apparatus since it is no longer required to store the or each earlier data sample in the memory. It will be appreciated that if data extends back for long periods of time (years worth of data is not uncommon) then the storage requirements for that data can become high.

Further, in addition to reducing the memory required by the apparatus, the speed at which calculation of the new ongoing weighted average is performed may be increased when compared to the prior art. Thus, acceptable performance may be obtained from the apparatus with a reduced specification of hardware.

The processing means may be arranged to use a geometrically weighted arithmetic to generate the ongoing weighted average. Such an arrangement is advantageous because it helps to reduce the weight that is applied to older earlier data samples and as such reduces the reliance on the older data which may be of less relevance.

Preferably, the processing means is further arranged to calculate an acceptable discrepancy limit for each new data sample that is received based on the ongoing weighted average that has been calculated for that new data sample. As with the ongoing weighted average the discrepancy limit has the characteristic that the contribution of any one exiting data sample to the discrepancy limit diminishes as each subsequent data sample is input.

The apparatus may further comprise a comparison means arranged to determine whether each data sample is within its associated acceptable discrepancy limit. The processing means may provide the comparison means.

Preferably, the analysis apparatus comprises a warning means arranged to produce a warning when a data sample is outside its associated acceptable discrepancy limit of its ongoing weighted average.

According to a second aspect of the invention there is provided a method of analysing data comprising collecting at least one data sample and using said data sample and an existing ongoing weighted average based upon at least one earlier data sample to calculate a new ongoing weighted average such that the weight applied to the or each earlier data sample is diminished without needing the value of the or each earlier data sample to calculate the new ongoing weighted average.

According to a third aspect of the invention there is provided a program arranged to cause a computer to collect at least one new data sample and using the new data sample and an existing ongoing weighted average based upon at least one earlier data sample and stored in a memory of the computer to calculate a new ongoing weighted average such that the or each respective weight applied to the or each earlier data sample used in the existing ongoing weighted average is diminished without needing the value of the or each earlier data sample to calculate the new ongoing weighted average.

According to a fourth aspect of the invention there is provided a computer readable medium containing instructions which when read onto a computer cause that computer to perform as the analysis apparatus of the first aspect of the invention.

According to a fifth aspect of the invention there is provided a computer readable medium containing instructions which when read onto a computer cause that computer to perform the method of the second aspect of the invention.

The machine readable medium of any of the aspects of the invention may be any one or more of the following: a floppy disk; a CDROM/RAM; a DVD ROM/RAM (including +R/RW, −R/RW); any form of magneto optical disk; a hard drive; a memory; a transmitted signal (including an internet download, file transfer, or the like); a wire; or any other form of medium.

A further aspect of the invention provides an analysis apparatus arranged to analyse data and detect change within the data, the apparatus comprising an input means capable of receiving and transmitting data to be input to the analysis apparatus, processing means capable of transmitting and receiving data and of performing processing thereon to determine results and memory means capable of receiving data, storing the data and allowing access to the data, wherein the input means is arranged to receive at least one data sample and to input the at least one data sample to the analysis apparatus, the processing means is arranged to receive a data sample from the input means and to perform processing thereon and the memory means is arranged to receive data from the processing means, to store the data and to allow the processing means access to the data, the apparatus being arranged such that, on receipt of a data sample, the processing means is arranged to access an existing ongoing weighted average and an existing ongoing weighted standard deviation, each based upon at least one earlier data sample held in the memory means, and to determine a new ongoing weighted average using the new data sample and the existing ongoing weighted average and a new ongoing weighted standard deviation using the new data sample and the existing ongoing weighted standard deviation wherein the new ongoing weighted average and standard deviation are determined such that the respective weight applied to the at least one earlier data sample is diminished without needing the value of the at least one earlier data sample to calculate the new ongoing weighted average or ongoing weighted standard deviation.

Use of the standard deviation in this manner may prove advantageous because it can be used to determine whether a data sample received by the analysis apparatus should be considered as a significant change from the ongoing weighted average. The standard deviation may be used to determine whether a data sample differs by more than an acceptable limit from previously received data samples.

It will be appreciated that a data sample may relate to anything that data may be used to represent. For example data may be used to represent any of the following non-exhaustive list: business related data such as sales figures, transactions, income expenditure, stock levels, orders and the like; data-traffic data such as available bandwidth, transfer rate and the like; financial information such as share prices, market levels, and the like.

A further aspect of the invention provides a method of analysing data comprising collecting at least one new data sample and using the new data sample and an existing ongoing weighted average based upon at least one earlier data sample to calculate a new ongoing weighted average and further using the new data sample and an existing ongoing weighted standard deviation based upon at least one earlier data sample to calculate a new ongoing weighted standard deviation such that the at least one respective weight applied to the at least one earlier data sample used to calculate the existing ongoing weighted average and the existing ongoing weighted standard deviation is diminished without needing the value of the at least one earlier data sample to calculate the new ongoing weighted average and ongoing standard deviation.

A further aspect of the invention provides a program capable of controlling a computer and arranged to cause a computer to collect at least one new data sample and using the new data sample and an existing ongoing weighted average based upon at least one earlier data sample and stored in a memory of the computer to calculate a new ongoing weighted average such that the at least one respective weight applied to the at least one earlier data sample used in the existing ongoing weighted average is diminished without needing the value of the at least one earlier data sample to calculate the new ongoing weighted average, the program being further arranged to use the new data sample and existing ongoing weighted standard deviation to calculate an ongoing weighted standard deviation in which the respective weight applies to at least one earlier data sample is diminished.

A further aspect of the invention provides a data processing apparatus capable of receiving and processing data and programmed to receive a succession of data samples and process the data samples to calculate a weighted average of the data samples and a weighted standard deviation of the data samples, the calculation being repeated in response to each successive data sample and being performed by reference to the value of the data sample, the next preceding weighted average of data samples and a number of data samples.

In a further aspect, the invention provides data processing apparatus programmed to receive a succession of data samples and to calculate a weighted average of the data samples, the calculation being repeated in response to each successive data sample and being performed by reference to the value of the data sample, the next preceding weighted average of data samples and the number of data samples.

### BRIEF DESCRIPTION OF THE DRAWINGS

Some embodiments of the present invention are now described by way of example only and with reference to the following Figures of which:

FIG. 1 shows two representations or normal distributions;

FIG. 2 shows a representation of a computer system;

FIG. 3 shows a flow chart outlining a method for carrying out one embodiment of the present invention;

FIG. 4 shows a schematic diagram of a system suitable for providing an embodiment of the invention; and

FIG. 5 shows a further embodiment of the present invention.

### DETAILED DESCRIPTION OF ILLUSTRATIVE EMBODIMENTS

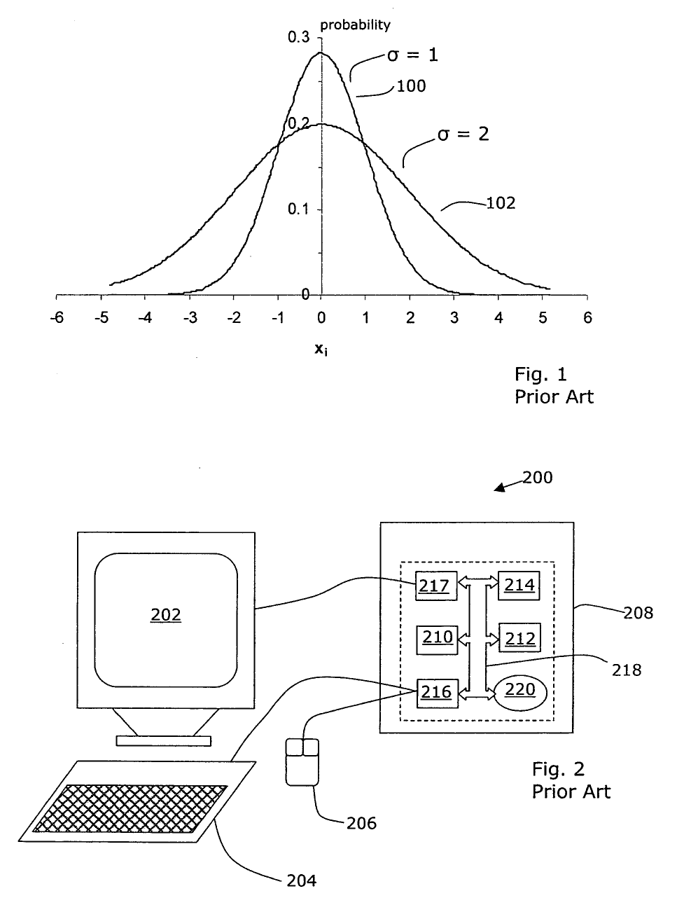

FIG. 1 shows a first and second normal distributions 100, 102 with their characteristic bell-shaped curves, both with means of zero. Normal distributions can be used to show the probability of obtaining a particular measurement as follows.

The first of these distributions 100 has a standard deviation (usually represented by the Greek letter sigma a) of one and forms a peak that is both narrower and higher when compared to the second distribution 102 with a standard deviation of two. This illustrates that the standard deviation is a measure of spread, or how diverse one might expect a data set to be under normal circumstance. As shown in the Figure, the probability of obtaining a value of three would be somewhat rare in the first distribution where σ=1 and decidedly more common in the second distribution where σ=2. In standard statistical tests, a data point is judged to be unusual if it falls outside of two, or possibly three, standard deviations of the mean, although this is somewhat arbitrary and it could be that any number (not necessarily integer) of standard deviations should be considered. Of course, it may be that these ‘unusual’ points are simply as expected from a system following a normal distribution-5% of points would normally fall outside of two standard deviations from the mean, 1% would fall outside of three standard deviations from the mean-but they could also be an indication of a system gone awry.

FIG. 2 shows a prior art computer 200 arranged to accept data and to process that data. The computer may therefore be thought of as an analysis apparatus or a data processing apparatus. The computer 200 comprises a display means 202, in this case a Cathode Ray Tube (CRT) display, a keyboard 204, a mouse 206 and processing circuitry 206.

The processing circuitry 206 comprises a processing means 210, a hard drive 212 (containing a store of data), memory 214 (RAM and ROM) (which comprises a memory means), an I/O subsystem 216 and a display driver 217 which all communicate with one another, as is known in the art, via a system bus 218. The I/O subsystem takes inputs from the mouse 206 and keyboard 204 (which therefore comprise input means or input devices) and the display driver 217 drives the display means 202. The processing means 210 typically comprises at least one INTEL™ PENTIUM™ series processor, running at generally between 2.4 GHz and 3.0 GHz (although it is of course possible for other processors to be used). Of course, other processors such as the AMD™ ATHLON™, POWERPC™, DIGITAL™ ALPHA™, processors are equally possible. Indeed, the processing means 210 may be provided by an ASIC (Application Specific Integrated Circuit), FPGA (Field Programmable Gate Array), or other similar devices.

As is known in the art the ROM portion of the memory 214 contains the Basic Input Output System (BIOS) that controls basic hardware functionality. The RAM portion of memory 214 is a volatile memory used to hold instructions that are being executed (such as program code), together with data etc. which can be accessed by the processing means 210. The hard drive 212 is used as mass storage for programs and other data. In the present example, the hard drive 212 is used to store data points.

Other devices such as CDROMS, DVD ROMS, network cards, etc. could be coupled to the system bus 218 and allow for storage of data, communication with other computers over a network, etc.

The processing circuitry 208 further comprises a transmitting/receiving means 220, which is arranged to allow the processing circuitry 208 to communicate with a network. The transmitting/receiving means 124 also communicates with the processing means 210 via the bus 218.

The processing circuitry 208 could have the architecture known as a PC, originally based on the IBM™ specification, but could equally have other architectures. For instance, the processing circuitry 208 may be an APPLE™, or may be a RISC system, and may run a variety of operating systems (perhaps HP-UX, LINUX, UNIX, MICROSOFT™ NT, AIX™, or the like). Or indeed, the processing apparatus may be a custom design which is not a recognised computer format.

In a first embodiment of the present invention, the invention is applied to tracking sales figures and determining whether recent sales data is outside a set of predetermined parameters. The predetermined parameters may mean that the new data sample is within an associated acceptable discrepancy limit that has been calculated for the new data sample. Data samples are received and stored in a memory of or accessible by the processing means 210.

It will be appreciated that although reference is made to a memory 214 it is possible that the memory could be provided by a variety of devices. For example, the memory may be provided by a cache memory, a RAM memory, a local mass storage device such as the hard disk 212, any of these connected to the processing circuitry 208 over a network connection such as via the transmitting/receiving means 220. However, the processing means 210 can access the memory via the system bus 218 to access program code to instruct it what steps to perform and also to access the data samples. The processing means 210 then processes the data samples as outlined by the program code.

In use of the system, one or more data samples are input into the computer 200 using the keyboard 204. The skilled user will appreciate that as data samples are input into the computer it will not be evident if any one or more data samples are anomalous until a history of data samples has been entered against which the entered data sample can be compared. Before the history is ‘statistically significant’, values towards the edges of what may be considered normal for the system may produce an average that is not the true mean for the system or the sample may be anomalous (i.e. outside the predetermined parameters). In the present example, it may be that a product performs well in its first week of launch as prior orders are filled and thus the initial data samples for that product are legitimately high. Alternatively, the product may under perform as it may not be at all sale sites or the availability of the product has not been advertised and again the initial data samples may again be accurate.

Thus, it will be appreciated that it may be hard to determine from a single data sample alone whether that data sample is outside the predetermined parameters, or whether that data sample is part of an ongoing trend. However, comparing the new data sample against an ongoing weighted average of the data may allow the system to determine data outside predetermined trends. However, in order to avoid maintaining large amounts of data samples from the past it is desirable to calculate the ongoing weighted average so that it does not require past data samples to be maintained.

The system of this embodiment uses such an ongoing weighted average. However, in order to achieve this, a suitable interval must be defined. Assuming that a retail outlet transmits its sale figures (i.e. a data sample) at the end of each week, it is likely that the previous month's figures are a good indication of whether the present figures are within the predetermined parameters (ignoring, for a moment, the seasonal variations in sales figures according to what the item is). In this example, it is decided that the sales figures from the preceding six months provide a good basis determining whether a weeks sales are inside the predetermined parameters that have been established. The data for the six months is represented by the preceding twenty-six data samples.

Data samples from before the preceding six months time will be incorporated in the ongoing weighted average, but the weighting on each data sample is such that the effect of data samples before the preceding six months on the ongoing weighted average are vanishingly small.

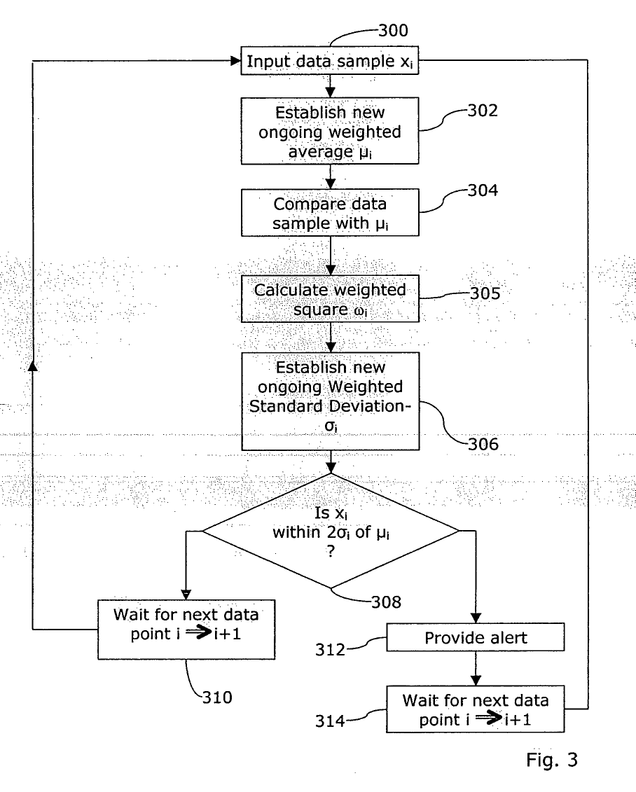

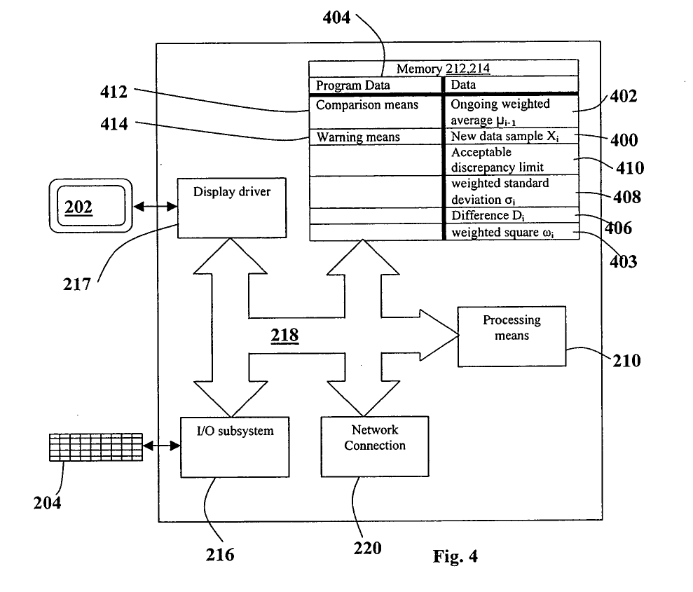

FIG. 3 summarises the processes undergone on receiving a data sample and FIG. 4 summaries the hardware that is used in realising the processes. For the present, it is assumed that the data gathering process has been ongoing for some time and that more than six months of data has been collected and an ongoing weighted average has already been established.

In step 300, a new data sample is received by processing circuitry 208 of the computer 200 when a user of the computer 200 makes an input using the keyboard 204. The processing means 210 receives the new data sample 400 and temporarily stores it in the memory 212,214. This new data sample 400 is labelled xᵢ marking it as the ith data sample, where i is an integer. The new data sample 400 is used in conjunction with an existing ongoing weighted average μᵢ₋₁ 402 (stored in the memory 212,214) to provide a new ongoing weighted average μᵢ in step 302 using the equation:

$${μ}_{i} = \frac{( ( p - 1 ) {μ}_{i - 1} + {x}_{i} )}{p}$$

where p is the number of data samples. As discussed above, a suitable number of data samples in the system described in this example is twenty-six (i.e. p=26). The existing ongoing weighted average μᵢ₋₁ can then be overwritten with the new ongoing weighted average μᵢ. In some embodiments the existing ongoing weighted average μᵢ₋₁ may be maintained concurrently with the newly calculated ongoing weighted average μᵢ₋₁.

In step 304, the processing circuitry 208 is controlled by the program data, or code 404 to find the arithmetic difference between the new data sample xᵢ 400 and the newly calculated ongoing weighted average μᵢ 402. This is performed by a subtraction:
Difference=Dᵢ=μᵢ−xᵢ

The difference Dᵢ 406 is then stored in the memory 212,214.

In step 305 an intermediate value, which may be thought of as a weighted square 403, is calculated, which in turn will allow a new ongoing weighted standard deviation to be calculated and stored in the memory 212,214. The equation used to calculate the weighted square 403 is as follows:

$$ϖ = \frac{( ( p - 1 ) {ϖ}_{i - 1} + {x}_{i}^{2} )}{p}$$

In step 306 the new data sample xᵢ 400 is used in conjunction with the intermediate value that has been calculated in step 305 to provide a new ongoing weighted standard deviation σᵢ 408 using the equation:

$${σ}_{i} = \sqrt{( \frac{{μ}_{i}^{2} - {ω}_{i}}{p} )}$$

As each new ongoing weighted standard deviation σᵢ is calculated, the previous value is simply overwritten within the memory 212,214.

In step 308, the difference Dᵢ 406 is compared with the new ongoing standard deviation σᵢ and the following condition is considered:
|Dᵢ|≦2σᵢ
where |Dᵢ| is the modulus, or magnitude, of Dᵢ. The result of this calculation is used to determine whether the data sample is within the predetermined parameters. The value of 2σᵢ may be thought of as providing an associated acceptable discrepancy limit that has been calculated for the new data sample and is stored in the memory (see 410).

A comparison means 412 is used to make this determination and if the modulus of Dᵢ is less than 2σᵢ then the program code loop and waits for the next data point xᵢ₊₁ to be received in step 310. The process described above then repeats with xᵢ=xᵢ₊₁.

If the comparison means 412 determines that the modulus of Dᵢ is not less than 2σᵢ, then the data point xᵢ can be considered to be significantly different from the ongoing weighted mean μᵢ; (i.e. is outside the predetermined parameters and consequently the new data sample is outside the associated acceptable discrepancy limit), and the display driver 217 receives a signal from the processing means 210 and controls the display means 202 to provide an onscreen warning to a user of the system as step 312. This display of a warning on the display 202 may be thought of as a warning means 414. The program code loop and waits for the next data point xᵢ₊₁ to be received in step 314. The process described above then repeats with xᵢ=xᵢ₊₁.

In a modification of the embodiment described in relation to FIGS. 1 to 3 the computer 200 may have a data feed input to the I/O subsystem 216. This data feed may provide the data samples and as such a user may not need to input data samples via the keyboard 204.

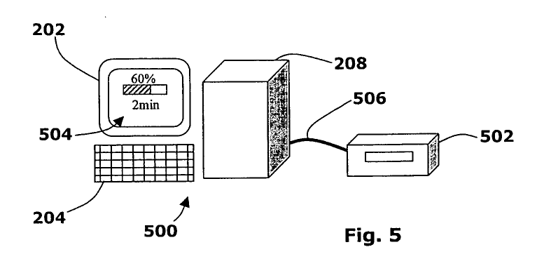

In a further embodiment of the invention, as described in relation to FIG. 5, there is provided a computer 500 which is connected to a backup device. In this embodiment the backup device is a tape-drive 502 but could equally be other storage devices such as a DVD writer, a hard drive array, a remote server or other computer, or the like. The computer may have the architecture described in relation to the computer 200 of FIG. 2 and will not be described again. For the sake of convenience like parts are referred to with the reference numerals of FIG. 2.

The tape-drive 502 connects to the I/O subsystem 216 which allows the processing means 210 to send data to the tape-drive 502 which can be stored on a tape within the drive generally for back-up purposes. The screen 202 of the computer 500 is arranged to show the progress of the file transfer, generally via a dialogue box, or the like, arranged to show the percentage of the transfer that has been completed (and by inference the percentage of the transfer that remains) together with the estimated time remaining. This is shown at 504 in the Figure and the example given shows that 60% of the transfer of data has been completed and that it is estimated that 2 minutes remain.

The tape drive 502 and the computer 500 are connected by a cable 506 (although wireless such as WIFI, or Bluetooth links would be equally possible) and communicate via the cable 506 using Universal Serial Bus 2.0 protocol (USB 2.0). Of course, other protocols such as SCSI, Firewire (IEEE 1394), Ethernet, and the like are all equally possible. The data transfer rate between the computer 500 and the tape-drive 502 is not constant and will depend upon factors such as whether the processing means 210 is performing tasks other transferring the data, whether there are other devices using the cable 506 to transmit data and similar reasons.

Because the data transfer rate varies it can the time remaining for the transfer to be completed is an estimate and cannot be determined precisely. However, the accurate estimation of the transfer time is a useful indicator in determining how the transfer is proceeding. If the transfer rate suddenly slows it may indicate that the connection between the computer 500 and the tape-drive 502 has failed, that the program code running on the processing means 210 has crashed, or the like.

Therefore, it is useful if the processing means 210 monitors the data transfer rate by taking a data sample of the transfer rate at predetermined time intervals. Such time intervals may be roughly 50 ms, 100 ms, 200 ms, 500 ms, 1 second, 5 seconds, any time in between these, or any suitable time. The data samples taken by the processing means 210 can then be applied to the method as described in relation to FIG. 3 to determine whether any of the data samples are outside the predetermined parameters. If the data sample is outside the predetermined parameter then a user of the computer 500 can be alerted to the potential problems with the data transfer.

1. An analysis apparatus arranged to analyse data and detect change within the data, the apparatus comprising an input means capable of receiving and transmitting data to be input to the analysis apparatus, processing means capable of transmitting and receiving data and of performing processing thereon to determine results, and memory means capable of receiving data, storing the data and allowing access to the data, wherein the input means is arranged to receive at least one data sample and to input the at least one data sample to the analysis apparatus, the processing means is arranged to receive a data sample from the input means and to perform processing thereon and the memory means is arranged to receive data from the processing means, to store the data and to allow the processing means access to the data, the apparatus being arranged such that, on receipt of a data sample, the processing means is arranged to access an existing ongoing weighted average based upon at least one earlier data sample held in the memory means and to determine a new ongoing weighted average using the new data sample and the existing ongoing weighted average wherein the new ongoing weighted average is determined such that the respective weight applied to the at least one earlier data sample is diminished without needing the value of the at least one earlier data sample to calculate the new ongoing weighted average.

2. An apparatus according to claim 1 in which the processing means is arranged to process the at least one data sample using geometrically weighted arithmetic to generate the ongoing weighted average.

3. An apparatus according to claim 1 or claim 2 in which the processing means is arranged to process the at least one data sample to determine an ongoing weighted standard deviation in which the weight applied to earlier data samples used to determine the weighted standard deviation is reduced.

4. An apparatus according to claim 3 in which the processing means is arranged to process the at least one data sample to determine an intermediate term in order to calculate the ongoing weighted standard deviation.

5. An apparatus according to claim 3 or 4 in which the processing means is further arranged to process the ongoing weighted standard deviation to determine an acceptable discrepancy limit for each new data sample using the ongoing weighted standard deviation.

6. An apparatus according to claim 5 in which apparatus comprises a comparison means capable of comparing data and arranged to compare each new data sample with the ongoing weighted average to determine whether each new data sample is within the acceptable discrepancy limit that has been determined for that new data sample.

7. An apparatus according to claim 6 which comprises a warning means capable of producing a warning and arranged to produce a warning when a new data sample is outside the acceptable discrepancy limit of the ongoing weighted average that has been calculated using that new data sample.

8. An apparatus according to any of claims 5 to 7 in which the processing means is arranged to determine the acceptable discrepancy limit as being a multiple number of the ongoing weighted standard deviation.

9. A method of analysing data comprising collecting at least one new data sample and using the new data sample and an existing ongoing weighted average based upon at least one earlier data sample to calculate new ongoing weighted average such that a respective weight applied to the at least one earlier data sample used to calculate the existing ongoing weighted average is diminished without needing the value of the at least one earlier data sample to calculate the new ongoing weighted average.

10. A method according to claim 9 in which an ongoing weighted standard deviation is calculated in which the weight applied to earlier data samples used to calculate the standard deviation is reduced.

11. A method according to claim 10 in which an acceptable discrepancy limit is calculated for each new data sample using the ongoing weighted standard deviation.

12. A method according to claim 11 in which a comparison is made between the ongoing weighted average and each new data sample to determine whether the new data sample is within the acceptable discrepancy limit.

13. A method according to claim 12 in which the acceptable discrepancy limit is twice the ongoing weighted standard deviation.

14. A program capable of controlling a computer and arranged to cause a computer to collect at least one new data sample and using the new data sample and an existing ongoing weighted average based upon at least one earlier data sample and stored in a memory of the computer to calculate a new ongoing weighted average such that the respective weight applied to the at least one earlier data sample used in the existing ongoing weighted average is diminished without needing the value of the at least one earlier data sample to calculate the new ongoing weighted average.

15. A computer readable medium containing instructions which when read on to a computer cause that computer to perform as the analysis apparatus of any of claims 1 to 8.

16. A computer readable medium containing instructions which when read onto a computer cause that computer to perform the method of any of claims 9 to 13.

17. A computer readable medium containing the program of claim 14.

18. Data processing apparatus capable of receiving and processing data and programmed to receive a succession of data samples and process the data samples to calculate a weighted average of the data samples, the calculation being repeated in response to each successive data sample and being performed by reference to the value of the data sample, the next preceding weighted average of data samples and a number of data samples.

19. A computer arranged to analyse data and detect changes therein comprising an input device, a processor and a memory, the input device being arranged to receive data and supply the data to the processor, the processor being arranged to receive the data and to access data from the memory, the processor being further arranged to process data and to supply data to the memory, the memory being arranged to receive data from the processor, to store data, and to allow access to the stored data, the computer being arranged such that, in use, the input device receives at least one data sample and supplies the data sample to the processor, the processor processes the data sample in conjunction with data comprising a weighted average accessed from the memory to determine a new weighted average, wherein the weighted average has been determined using previously input data samples and the processing is such that the weight applied to each data sample in determining the new weighted average is diminished as each new data sample is added.

20. An analysis apparatus arranged to analyse data and detect change within the data, the apparatus comprising an input means capable of receiving and transmitting data to be input to the analysis apparatus, processing means capable of transmitting and receiving data and of performing processing thereon to determine results and memory means capable of receiving data, storing the data and allowing access to the data, wherein the input means is arranged to receive at least one data sample and to input the at least one data sample to the analysis apparatus, the processing means being arranged to receive a data sample from the input means and to perform processing thereon and the memory means is arranged to receive data from the processing means, to store the data and to allow the processing means access to the data, the apparatus being arranged such that, on receipt of a data sample, the processing means is arranged to access an existing ongoing weighted average and an existing ongoing weighted standard deviation, each based upon at least one earlier data sample held in the memory means, and to determine a new ongoing weighted average using the new data sample and the existing ongoing weighted average and a new ongoing weighted standard deviation using the new data sample and the existing ongoing weighted standard deviation wherein the new ongoing weighted average and standard deviation are determined such that the respective weight applied to the at least one earlier data sample is diminished without needing the value of the at least one earlier data sample to calculate the new ongoing weighted average or ongoing weighted standard deviation.

21. A method of analysing data comprising collecting at least one new data sample and using the new data sample and an existing ongoing weighted average based upon at least one earlier data sample to calculate a new ongoing weighted average and further using the new data sample and an existing ongoing weighted standard deviation based upon at least one earlier data sample to calculate a new ongoing weighted standard deviation such that the at least one respective weight applied to the at least one earlier data sample used to calculate the existing ongoing weighted average and the existing ongoing weighted standard deviation is diminished without needing the value of the at least one earlier data sample to calculate the new ongoing weighted average and ongoing weighted standard deviation.

22. A program capable of controlling a computer and arranged to cause a computer to collect at least one new data sample and using the new data sample and an existing ongoing weighted average based upon at least one earlier data sample and stored in a memory of the computer to calculate a new ongoing weighted average such that the at least one respective weight applied to the at least one earlier data sample used in the existing ongoing weighted average is diminished without needing the value of the at least one earlier data sample to calculate the new ongoing weighted average, the program being further arranged to use the new data sample and existing ongoing weighted standard deviation to calculate an ongoing weighted standard deviation in which the respective weight applies to at least one earlier data sample is diminished.

23. Data processing apparatus capable of receiving and processing data and programmed to receive a succession of data samples and process the data samples to calculate a weighted average of the data samples and a weighted standard deviation of the data samples, the calculation being repeated in response to each successive data sample and being performed by reference to the value of the data sample, the next preceding weighted average of data samples and a number of data samples.

24. A method of determining whether a new data sample should be considered to differ by more than an acceptable limit from a set of earlier received data samples comprising applying the method of claim 9 to the new and the set of earlier received data samples.

25. A method of determining whether a new data sample should be considered to differ by more than an acceptable limit from a set of earlier received data samples comprising applying the method of claim 21 to the new and the set of earlier received data samples.
